(19) United States
(12) Patent Application Publication
(10) Pub. No.: US 2007/0021009 A1
(43) Pub. Date: Jan. 25, 2007

(54) Protective structure for removable hard disk

(76) Inventors: Yu Wen Tsai, Taipei (TW); Li-Chu Yu, Taipei (TW); Yi-Chia Chen, Tainan City (TW)

Correspondence Address: BRUCE H. TROXELL;SUITE 1404, 5205 LEESBURG PIKE, FALLS CHURCH, VA, 22041, US

(21) Appl. No.: 11/233,046

(22) Filed: Sep. 23, 2005

(30) Foreign Application Priority Data
Jul. 25, 2005 (TW) 94212552

(51) Int. Cl. H01R 24/00

(52) U.S. Cl. 439/630

(57) ABSTRACT

A structure for protecting a removable HD comprising a casing for receiving the HD, a terminal adapter for connecting to terminals of the HD at one end, the terminal adapter including terminals at the other end, a seat for releasably securing to the casing, and a circuit board mounted in the seat, the circuit board including terminals adapted to releasably connect to the terminals of the terminal adapter. The casing comprises a positioning member (e.g., latch) at one end and two lengthwise rails formed along its both sides respectively. The seat comprises a mated positioning member (e.g., transverse positioning bar at one end) and two elongate grooves formed along its both sides respectively. The rails are adapted to slide along the grooves, and the mated positioning member is adapted to lockingly engage the positioning member when the casing is inserted into the seat.

### BACKGROUND OF THE INVENTION

1. Field of the Invention

The present invention relates to protective structures of electronic devices and more particularly to a protective structure (e.g., open case) for a removable hard disk with improved characteristics.

2. Related Art

A wide variety of electronic products (e.g., PCs (personal computers), notebooks, digital cameras, AV players, or the like) are available in an even faster pace in recent years due to rapid progress of electronics technology. Also, hard disks (HDs) of ultra-high capacity are available for meeting increasing memory capacity needs. Further, data stored in a HD of one electronic device may be required to use in another electronic device in a way other than sending e-mails thereto. Thus, it is important to quickly remove a HD from one electronic device and then safely install same in another electronic device.

A number of memory devices (e.g., Compact Flash cards, Secure Digital cards, etc.) or extended storages are available in the shape of a thin plate (or card). Such card typically has a plurality of terminals arranged in parallel rows at one end thereof. The terminals are adapted to connect to an adapter which is in turn adapted to connect to a computer or the like. But such memory devices are not high-capacity forms of storage. Hence, it is anticipated that the current memory devices are insufficient for future use.

HD is a very advanced device. Also, HD is a high-capacity form of storage. However, read/write head and sectors of HD and thus HD are subject to damage due to collision or other undesired reasons. Also, terminals in the shape of pin are also subject to damage or deformation due to collision or disassembly. In short, a HD and its terminals are required to be well protected in transportation or carrying.

Some types of HD are removable by unfastening screws from an electronic device. Also, removed HD is required to safely mount in a protective structure in order to ensure a safe installation at another device.

### SUMMARY OF THE INVENTION

It is therefore an object of the present invention to provide a structure for protecting a removable HD comprising a casing for receiving the HD; a terminal adapter for connecting to terminals of the HD at one end, the terminal adapter including a plurality of terminals at the other end; a seat for releasably securing to the casing; and a circuit board mounted in the seat, the circuit board including a plurality of terminals adapted to releasably connect to the terminals of the terminal adapter.

In one aspect of the present invention, the casing comprises a positioning member and two lengthwise rails formed along its both sides respectively, and the seat comprises a mated positioning member and two elongate grooves formed along its both sides respectively, the rails are adapted to slide along the grooves, and the mated positioning member is adapted to lockingly engage the positioning member when the casing is inserted into the seat.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of protective structure (e.g., case) according to the invention and a HD to be assembled therewith;

FIG. 2 is a cross-sectional view of a portion of the casing shown in FIG. 1; and

FIGS. 3 and 4 are views similar to FIG. 2 for illustrating an assembly of the casing and the seat by insertion.

### DETAILED DESCRIPTION OF THE INVENTION

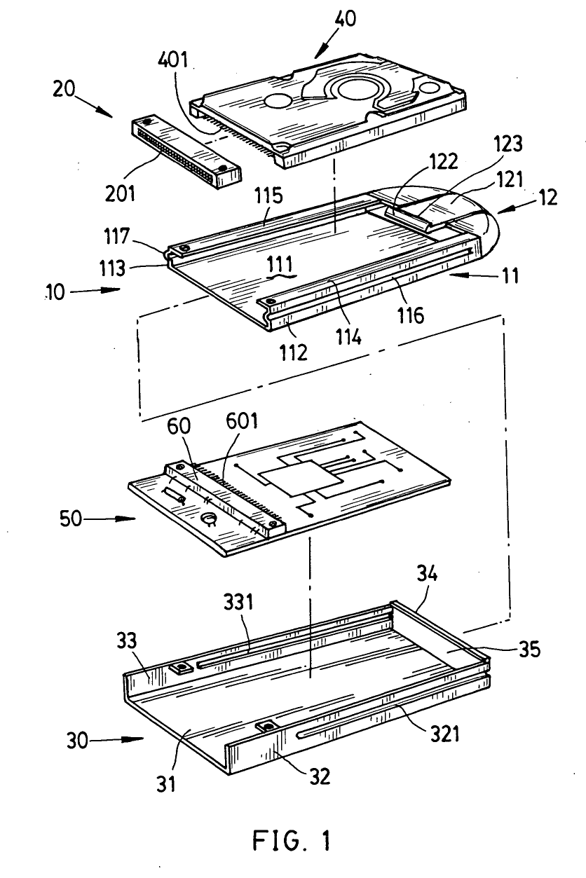

Referring to FIG. 1, a protective structure (e.g., case) for a removable hard disk in accordance with a preferred embodiment of the invention comprises a casing 10, a terminal adapter 20, and a seat 30. A HD 40 is to be mounted in the casing 10. A circuit board 50 is mounted in the seat 30.

The casing 10 is adapted to protect the HD 40 and is adapted to releasably connect to the seat 30. The casing 10 comprises a rectangular body 11 and a fastening member 12 formed at one end of the body 11. The body 11 comprises a bottom plate 111, two sidewalls 112 and 113, upper plates 114 and 115 integrally formed on tops of the sidewalls 112 and 113 respectively, and lengthwise rails 116 and 117 formed on the sidewalls 112 and 113 respectively. The fastening member 12 comprises a flexible latch 121 and a hook 123 at an open end of the latch 121, the hook 123 having an arcuate outer surface 122. The HD 40 is adapted to mount in the body 11 and is fitted in and protected by the bottom plate 111, the sidewalls 112 and 113, and the upper plates 114 and 115.

The HD 40 comprises a plurality of terminals 401 formed at its forward end. The terminals 401 are shaped as pins and are arranged in parallel rows. However, the terminals 401 are subject to damage due to expose. Advantageously, the terminal adapter 20 is provided by the invention. The terminal adapter 20 is adapted to connect to the terminals 401 at its one end and has a plurality of apertures 201 arranged in parallel rows in the other end for connecting to another component. The terminal adapter 20 is adapted to protect the terminals 401 of the HD 40. Further, the terminal adapter 20 is not subject to damage because there are no projecting terminals.

The casing 10, the HD 40, and the terminal adapter 20 together form a case. The case is adapted to releasably insert into the seat 30. In an inserted state of the HD 40, the HD 40 is protected by the casing 10 and the terminal adapter 20. Further, the removed HD 40 can be carried easily.

The seat 30 comprises a bottom plate 31, two sidewalls 32 and 33, and a transverse positioning bar 34 at one end. The circuit board 50 is adapted to mount on the bottom plate 31 between the sidewalls 32 and 33. The circuit board 50 comprises circuitry. A terminal seat 60 is formed on a top surface of the circuit board 50 proximate the other end. The terminal seat 60 comprises a plurality of terminals 601 disposed to be matingly engage the terminals 201. Also, no obstacle is present between the terminals 601 and a rear opening 35 of the seat 30. That is, there is no obstacle present when both the casing 10 and the terminal adapter 20 are either inserted into the rear opening 35 or removed therefrom. As an end, the terminals 601 can be easily inserted into the terminals 201.

One sidewall 32 comprises an elongate groove 321 disposed corresponding to the rail 116 and the other sidewall 33 comprises an elongate groove 331 disposed corresponding to the rail 117. The rails 116 and 117 are adapted to snugly insert into the grooves 321 and 331 for ensuring a smooth, reliable fastening of the casing 10 and the seat 30 when the casing 10 is inserted into the seat 30 through the rear opening 35. As an end, the terminals 201 and 601 are securely engaged.

The transverse positioning bar 34 is formed on top of the rear opening 35 of the seat 30. The positioning bar 34 is adapted to cooperate with the fastening member 12. The fastening member 12 is mounted (or integrally formed) at one end of the body 11.

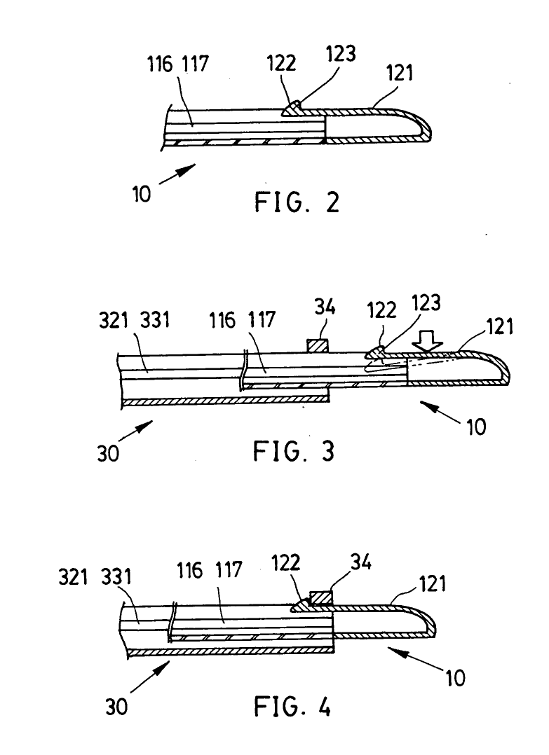

Referring to FIGS. 2, 3, and 4, an assembly of the casing 10 and the seat 30 is illustrated. The casing 10 is adapted to insert into the seat 30 by cooperating the rails 116 and 117 with the grooves 321 and 331. A user may press the latch 121 to cause the outer surface 122 to pass an underside of the positioning bar 34 until the positioning bar 34 is fastened by the upward jumping hook 123 at an end of the insertion. At this position, the casing 10 and the seat 30 are fastened together. For removing the casing 10 simply press the latch 121 until the latch 121 is disposed below the positioning bar 34. Next, pull the latch 121 outward to cause it to pass under the positioning bar 34. As an end, the casing 10 is removed from the seat 30.

While the invention herein disclosed has been described by means of specific embodiments, numerous modifications and variations could be made thereto by those skilled in the art without departing from the scope and spirit of the invention set forth in the claims.

What is claimed is:

1. A structure for protecting a removable HD comprising:
a casing for receiving the HD;
a terminal adapter for connecting to terminals of the HD at one end, the terminal adapter including a plurality of terminals at the other end;
a seat for releasably securing to the casing; and
a circuit board mounted in the seat, the circuit board including a plurality of terminals adapted to releasably connect to the terminals of the terminal adapter.

2. The structure of claim 1, wherein the casing comprises a bottom plate, two sidewalls, and two upper plates integrally formed on tops of the sidewalls respectively, and wherein the HD is fitted in the casing.

3. The structure of claim 4, wherein the seat further comprises two elongate grooves along its both sidewalls respectively.

4. The structure of claim 1, wherein the casing comprises a positioning member, and wherein the seat comprises a mated positioning member adapted to lockingly engage the positioning member.

5. The structure of claim 4, wherein said a positioning member comprises a flexible latch, and in front of the latch there is a hook, and wherein said a seat, at the position coordinated to the hook, a positioning bar is assembled, it is used to click with the hook.
